(19) United States
(12) Patent Application Publication
(10) Pub. No.: US 2022/0009055 A1
(43) Pub. Date: Jan. 13, 2022

(54) ABRASIVE WATERJET CUTTING SYSTEM, NOZZLE FOR SUCH A SYSTEM AND MONITORING PROCESS FOR SUCH AN ABRASIVE WATERJET CUTTING SYSTEM

(71) Applicant: UNIVERSITÉ DU LUXEMBOURG, Esch-sur-Alzette (LU)

(72) Inventor: Edoardo COPERTARO, Luxembourg (LU)

(21) Appl. No.: 17/279,424

(22) PCT Filed: Sep. 26, 2019
(86) PCT No.: PCT/EP2019/076119

§ 371 Date: Mar. 24, 2021

(30) Foreign Application Priority Data
Sep. 26, 2018 (LU) 100936

(51) Int. Cl. B24C 1/04; B24C 5/04

(52) U.S. Cl. CPC B24C 1/045; B24C 5/04

(57) ABSTRACT

The invention relates to an abrasive wateget cutting system (2) including: an abrasive watcrjct cutting head (14) comprising: a nozzle (16) adapted for guiding an abrasive wateget (6) intended to cut a metallic workpiece (4); an abrasive wateget flow direction (12); a monitoring device (28) including at least an upstream sensor and a downstream sensor which are distributed along the abrasive wateget flow direction (12) downstream the inlet end of the nozzle (16), and which are adapted for measuring at least one wear characteristic of the nozzle (16) or a characteristic of the abrasive wateget (6), or an alignment characteristic of the nozzle (16) with an orifice (18). The sensors comprise a set of accelerometers (40; 42) and a set of microphones (44; 46). The wear monitoring device (28) being configured to monitor at least one characteristic of the abrasive wateget cutting system (2) through at least the upstream sensor and the downstream sensor.

### TECHNICAL FIELD

The invention lies in the field of abrasive waterjet cutting. More precisely, the invention concerns a device and a method for monitoring an abrasive waterjet cutting head operation and notably the wear progression of its components. The invention also provides a nozzle for an abrasive waterjet cutting system, a computer program, and a computer.

### BACKGROUND OF THE INVENTION

Abrasive waterjet technology permits to cut hard materials such as alloys and stones. This manufacturing process is peculiarly interesting since it does not heat the workpiece during cutting operations. Thus, it does not affect the intrinsic properties of the material along the cutting contour.

This benefit is highly appreciated in the aeronautic domain where homogeneous material properties are closely connected to reliability. In addition, the precision and the quality of the produced goods reach high standards.

This manufacturing technology requires a high-pressure water source and an abrasive medium, notably particles made of hard material. High-pressure water is accelerated through an orifice, resulting in a high-speed water jet. Particles are fed into a mixing chamber. The resulting mixture is driven through a tube, also known as “nozzle”, where momentum transfer from water jet to particles occurs, the latter being consequently accelerated. The nozzle also possesses a collimator function. At the outlet, the mixture forms a cutting flow that progressively erodes the workpiece due to repeated collisions of the abrasive particles.

During operation, an abrasive waterjet (AWJ) cutting system generally generates dusts, vibrations, noise, and projections. Some of these parameters are conveniently used by monitoring devices for controlling the cutting operation, or for detecting an inner defect of the AWC system. For instance; the wear state of the nozzle may be estimated. Similar estimations may be carried out with respect to the orifice of the high-pressure fluid source. A misalignment may also be detected.

For these purposes, different kinds of sensors may be used. However, the latter remain exposed to the severe environment conditions that may damage them and/or alter the monitoring accuracy.

Moreover, the known monitoring devices remain of reduced relevance and provide limited info with regard to overall functioning if not properly included into an integrated monitoring infrastructure, as well as supported with dedicated data analysis.

The document FR 2 699 852 A1 discloses an abrasive waterjet system with a nozzle and acoustic sensors at distance from the nozzle. The head supporting the nozzle receives one sensor. The document US 2014/130576 A1 discloses a system with a nozzle for spraying a three-phase mixture. A single structure-borne sound sensor is assigned to the nozzle. A computation unit calculates a mean volumetric flow.

### Technical Problem to be Solved

It is an objective of the invention to present an abrasive waterjet cutting system which overcomes at least some of the disadvantages of the prior art. In particular, it is an objective of the invention to improve the monitoring accuracy of an abrasive waterjet cutting system.

### SUMMARY OF THE INVENTION

According to a first object, the invention provides an abrasive waterjet cutting system including: an abrasive waterjet cutting head comprising: a nozzle adapted for guiding an abrasive waterjet intended to cut a workpiece, optionally a metallic workpiece, said nozzle including an inlet end, an outlet end, and an outlet section; an abrasive waterjet flow direction, a first direction and a second direction; a monitoring device including means for measuring vibrations along the first direction and along the second direction; along the abrasive waterjet flow direction said means are at the outlet section of the nozzle, and said means are adapted for providing different signals in order to measure at least one wear characteristic of the nozzle, or a characteristic of the abrasive waterjet, or an alignment characteristic of the nozzle with an orifice; the monitoring device being configured for monitoring at least one characteristic of the abrasive waterjet cutting system through said means for measuring vibrations.

It is another object of the invention to provide an abrasive waterjet cutting system including an abrasive waterjet cutting head comprising: a nozzle adapted for guiding an abrasive waterjet intended to cut a workpiece, optionally a metallic workpiece, said nozzle including an inlet end and an outlet end; an abrasive waterjet flow direction; a monitoring device including at least an upstream sensor and a downstream sensor which are distributed along the abrasive waterjet flow direction downstream the inlet end of the nozzle, and which are adapted for measuring at least one wear characteristic of the nozzle or a characteristic of the abrasive waterjet, or an alignment characteristic of the nozzle with an orifice; the monitoring device being configured to monitor at least one characteristic of the abrasive waterjet cutting system through at least the upstream sensor and the downstream sensor.

It is another object of the invention to provide an abrasive waterjet cutting system including: an abrasive waterjet cutting head comprising: a nozzle adapted for guiding an abrasive waterjet intended to cut a workpiece, optionally a metallic workpiece, said nozzle including an inlet end and an outlet end which is formed by an outlet section; an abrasive waterjet flow direction; a monitoring device including at least a first sensor and a second sensor which are, along the abrasive waterjet flow direction, at the outlet section of the nozzle, and which are adapted for providing different signals in order to measure at least one wear characteristic of the nozzle, or a characteristic of the abrasive waterjet, or an alignment characteristic of the nozzle with an orifice; the monitoring device being configured for monitoring at least one characteristic of the abrasive waterjet cutting system through at least the first sensor and the second sensor.

Preferably, the upstream sensor and the downstream sensor may include an upstream accelerometer and a downstream accelerometer which may be attached to the abrasive waterjet cutting head for measuring wear characteristics of the nozzle and/or misalignment of waterjet respect to nozzle, optionally for measuring vibrations of the nozzle.

Preferably, the abrasive waterjet cutting head may include a casing housing the nozzle, said casing optionally including pockets where the upstream accelerometer and the downstream accelerometer are arranged.

Preferably, the nozzle may include an inlet section forming the inlet end and receiving the upstream accelerometer, and an outlet section forming the outlet end and receiving the downstream accelerometer; preferably the inlet section and the outlet section may each extend along at most 20% of the length of the nozzle, more preferably along at most 10% of the length of the nozzle.

Preferably, the nozzle may include a tubular body with a cylindrical tubular external surface, the upstream accelerometer and the downstream accelerometer possibly being in contact of said tubular body, optionally through glue or adhesive.

Preferably, the upstream sensor and the downstream sensor may include an upstream microphone and a downstream microphone disposed downstream the nozzle.

Preferably, the abrasive waterjet cutting head may include a frame supporting the upstream microphone and the downstream microphone.

Preferably, the monitoring device may further include a piezoelectric sensor which is adapted for being fixed to the workpiece, the wear monitoring device may be configured to monitor at least one characteristic of the abrasive waterjet cutting system through the piezoelectric sensor.

Preferably, along the abrasive waterjet flow direction, the abrasive waterjet cutting system may include a first distance D1 between the outlet end and the upstream microphone, and a second distance D2 between the upstream microphone and the downstream microphone, said second distance D2 being greater than the first distance D1, preferably at least two times as great as the first distance D1.

Preferably, the abrasive waterjet cutting head may comprise a main support and reversible fixation means for fixing the upstream sensor and the downstream sensor to the main support.

Preferably, the abrasive waterjet cutting head may enclose an orifice which is coaxial with the nozzle and an orifice sensor, optionally a strain-gauge sensor, for measuring a fluid pressure upstream the orifice.

Preferably, the upstream sensor and the downstream sensor may form a first set of sensors, the monitoring device further including a second set of sensors with a second upstream sensor and a second downstream sensor which may be adapted for measuring a wear characteristic of the nozzle and/or a characteristic of the abrasive waterjet, and/or an alignment characteristic of the nozzle with an orifice.

Preferably, the monitoring device may include a distance D3 along the abrasive waterjet flow direction which separates the first set of sensors from the second set of sensors.

Preferably, the sensors of the first set may be of a different kind than the sensors of the second set.

Preferably, the upstream sensor and the downstream sensor or the first sensor and the second sensor, or the means for measuring vibrations may be a microphone sensor and an accelerometer sensor.

Preferably, the abrasive waterjet cutting system may comprise means for computing a benchmark of the abrasive waterjet cutting head through at least one of the upstream sensor and the downstream sensor; means for obtaining an upstream data stream and a downstream data stream with the upstream sensor and the downstream sensor respectively; means for processing the upstream data stream and the downstream data stream in order to define a signature of the abrasive waterjet cutting head; and means for comparing the signature to the benchmark.

Preferably, the abrasive waterjet cutting system may comprise means for computing a static pressure and a dynamic pressure, preferably upstream the orifice, through a Fourier Transform or a Wavelet Transform, and means for comparing of said Fourier Transform or said Wavelet Transform to a first benchmark.

Preferably, the abrasive waterjet cutting system may comprise means for processing a net signal calculated with the upstream data and the downstream data, said net signal being optionally calculated by a decorrelation technique.

Preferably, the abrasive waterjet cutting system may comprise means for processing a net signal ; preferably calculated with the upstream data, the downstream data, and the data from the workpiece sensor such as a piezo electric sensor, which is fixed to the workpiece; said net signal being processed.

Preferably, the abrasive waterjet cutting system may comprise means for computing a Fourier Transform or a Wavelet Transform of the net signal, and means for comparing said Fourier Transform or Wavelet Transform to a second benchmark.

Preferably, the abrasive waterjet cutting system may comprises means for estimating the Fourier Transform or Wavelet Transform, preferably of the inlet signal from the upstream accelerometer arranged at the inlet end of the nozzle or the outlet signal from the downstream accelerometer arranged at the outlet end of the nozzle, the abrasive waterjet cutting system may comprise means for comparing said Fourier Transform or Wavelet Transform to a third benchmark.

Preferably, the abrasive waterjet cutting system may comprise means for calculating a vibration transmissibility by means of the upstream accelerometer the downstream accelerometer; and may further comprise means for comparing said vibration transmissibility to a fourth benchmark.

Preferably, the upstream sensor and the downstream sensor may be at opposite ends of the nozzle.

Preferably, the nozzle may comprise an adaptor fixed to the body and, the adaptor may comprise at least one cavity for fixing the vibration sensors or the means for measuring vibrations, said at least one cavity optionally being a side cavity.

Preferably, the adaptor may be configured for providing a protection portion between the workpiece and the vibration sensors or the means for measuring vibrations, or the upstream sensor and the downstream sensor.

Preferably, the adaptor may comprise a central hole fitting the body of the nozzle.

Preferably, the nozzle may be a nozzle element, possibly with an inner surface adapted for being in contact with the abrasive waterjet.

Preferably, the upstream sensor and the downstream sensor are adapted for providing data and/or signals in order to measure at least one wear characteristic of the nozzle, or a characteristic of the abrasive waterjet, or an alignment characteristic of the nozzle with an orifice.

Preferably, the casing may be fixed to the main support through the reversible fixation means.

Preferably, the upstream sensor and the downstream sensor may be of the same kind.

Preferably, the first set and the second set may be diametrically opposite with respect to the abrasive waterjet, and/or on the other circumferential side” of the waterjet.

Preferably, at least one or each accelerometer may be configured for measuring vibrations in three directions.

Preferably, the system may exhibit a cutting stage downstream the nozzle, the microphones being arranged in said cutting stage.

Preferably, the system may include a nozzle stage enclosing the nozzle, a cutting stage optionally between the nozzle and a workpiece receiving area, a monitoring zone optionally enclosing the nozzle stage and the cutting stage, the sensors may be arranged in the monitoring zone.

Preferably, the accelerometers may be arranged upstream at least one microphone, and/or between the strain-gauge sensor and at least one microphone, and/or between the strain-gauge sensor and the set of microphones.

Preferably, the abrasive waterjet cutting head may further include a mixing chamber upstream the upstream sensor, optionally the upstream accelerometer.

Preferably, the nozzle may include a conical recess communicating with the mixing chamber.

Preferably, the piezoelectric sensor may be disposed downstream the microphones.

It is another object of the invention to provide an abrasive waterjet cutting system including:

an abrasive waterjet cutting head comprising:

a nozzle adapted for guiding an abrasive waterjet intended to cut a workpiece, optionally intended

to cut a metallic workpiece, said nozzle including:
an inlet end,
an outlet end, and
a longitudinal direction;

a workpiece reception area;

a monitoring zone projecting from the workpiece reception area to the inlet end;

a wear monitoring device including:
an upstream sensor and a downstream sensor which are arranged in the monitoring zone,
and a longitudinal separation between the upstream sensor and the downstream sensor;

the wear monitoring device being configured to monitor the abrasive waterjet cutting system through the upstream sensor and the downstream sensor.

It is another object of the invention to provide an abrasive waterjet cutting system including:

an abrasive waterjet cutting head comprising:

a nozzle intended to be in contact of an abrasive waterjet adapted for cutting a workpiece,

optionally a metallic workpiece, said nozzle including:
an inlet section, and
an outlet section;

an orifice upstream the nozzle;

the system further including an alignment monitoring device for controlling the alignment of the orifice with respect to the nozzle, the misalignment monitoring device including an upstream accelerometer in contact of the upstream section of the nozzle.

It is another object of the invention to provide an abrasive waterjet cutting system including:

an abrasive waterjet cutting head comprising:

a nozzle for guiding an abrasive waterjet adapted for cutting a workpiece, optionally adapted for cutting a metallic workpiece, said nozzle including:
an inlet section, and
an outlet section which are at opposite ends of the nozzle;

an abrasive waterjet flow direction; and

a monitoring device, optionally a nozzle wear monitoring device, including:
an upstream accelerometer in contact of the upstream section and
a downstream accelerometer in contact of the downstream section of the nozzle, the monitoring device being configured to monitor the abrasive waterjet cutting system by means of the upstream accelerometer and the downstream accelerometer.

It is another object of the invention to provide an abrasive waterjet cutting system including: an abrasive waterjet cutting head comprising:

a nozzle for guiding an abrasive waterjet adapted for cutting a workpiece, optionally adapted for cutting a metallic workpiece, said nozzle including:
an inlet section, and
an outlet section;

an abrasive waterjet flow direction;

a monitoring device, optionally a jet quality monitoring device, including:
an upstream microphone,
a downstream microphone, and possibly
a workpiece sensor, optionally a piezoelectric sensor, intended to be fixed to the workpiece,
the microphones, and possibly the workpiece sensor, are arranged downstream the nozzle, the upstream microphone being nearer from the outlet section than the downstream microphone and possibly than the workpiece sensor,

the monitoring device being configured to monitor the abrasive waterjet cutting system through the microphones and possibly the workpiece sensor.

It is another object of the invention to provide a nozzle, said nozzle including: a cylindrical body, a passage across the cylindrical body for guiding an abrasive waterjet, a longitudinal direction along the passage, optionally a vertical direction, two longitudinally opposite end sections, a vibration sensor at each end section.

It is another object of the invention to provide a nozzle for an abrasive waterjet cutting system, said nozzle including: an essentially cylindrical body, a passage across the essentially cylindrical body for guiding an abrasive waterjet, a longitudinal direction along the passage, optionally a vertical direction, two longitudinally opposite end sections, means for measuring vibrations in two transversal directions, said means being disposed at one of the two longitudinal opposite end sections.

It is another object of the invention to provide a nozzle for an abrasive waterjet cutting system (2), said nozzle including: a body which is a one-piece element and which comprises a generally cylindrical outer surface; a passage across the essentially cylindrical body for guiding an abrasive waterjet, a longitudinal direction along the passage, optionally a vertical direction, two longitudinally opposite end sections, at least two flat surfaces adapted for receiving vibration sensors or means for measuring vibrations in two directions which are transversal with respect to each other, said at least two flat surfaces: being inclined with respect to each other, being formed on the generally cylindrical outer surface, and being disposed at one of the two longitudinal opposite end sections, optionally an outlet end section.

Preferably, the vibration sensors or the means for measuring vibrations may be accelerometers, preferably multidirectional accelerometers, more preferably three-dimensional accelerometers.

Preferably, the cylindrical body may include a cylindrical outer surface which is adapted for receiving the vibration sensors directly or indirectly.

Preferably, the vibration sensor(s) may be fixed indirectly by means of the adaptor.

Preferably, the nozzle may comprise an adaptor fixed to the body and may comprise at least one side flat surface on which the vibration sensors or the means for measuring vibrations may be disposed.

Preferably, the means for measuring vibrations may comprise two unidirectional accelerometers which are disposed in order to measure vibrations in the two transversal directions.

Preferably, the two unidirectional accelerometers may be at distance around the essentially cylindrical body.

Preferably, the means for measuring vibrations comprise one multidimensional accelerometer.

Preferably, the transversal directions may be transversal with respect to the longitudinal direction, preferably the transversal directions may be perpendicular with respect to each other and with respect to the longitudinal direction.

Preferably, the essentially cylindrical body may comprise at least one facet receiving the means for measuring vibrations.

Preferably, the two longitudinally opposite end sections may comprise an inlet end section and an outlet end section, the means for measuring vibrations may be at the outlet end section.

Preferably, the means for measuring vibrations may be disposed at one plane which is perpendicular to the longitudinal direction.

Preferably, the nozzle may comprise threaded holes for fixing the vibration sensors or the means for measuring vibrations, said threaded holes may be formed on the essentially cylindrical body or on adaptor.

Preferably, the nozzle may comprise a shield disposed between an outlet end and the vibration sensors or the means for measuring vibrations, said shield is intended to protect the vibration sensors or the means for measuring vibrations from the waterjet that is scattered from the workpiece.

It is another object of the invention to provide a monitoring process of an abrasive waterjet cutting system, the abrasive waterjet cutting system comprising: an abrasive waterjet cutting head with a nozzle guiding an abrasive waterjet, said nozzle including an inlet end and an outlet end; an abrasive waterjet flow direction, a monitoring device including an upstream sensor and a downstream sensor which are adapted for measuring a wear characteristic of the nozzle, or a characteristic of the abrasive waterjet, or an alignment characteristic of the nozzle with an orifice; the monitoring process including the following steps: (b) defining a benchmark of the abrasive waterjet cutting head by means of at least one of the upstream sensor and the downstream sensor; (d) measuring an upstream data stream and a downstream data stream with the upstream sensor and the downstream sensor respectively; (e) processing the upstream data stream and the downstream data stream in order to define a signature of the abrasive waterjet cutting head; (f) comparing the signature to the benchmark; the abrasive waterjet cutting system being optionally in accordance with the invention.

It is another object of the invention to provide a monitoring process of an abrasive waterjet cutting system, the abrasive waterjet cutting system comprising: an abrasive waterjet flow direction, a first direction, a second direction, an abrasive waterjet cutting head with a nozzle guiding an abrasive waterjet, said nozzle including an inlet end, an outlet end, an outlet section; a monitoring device including, at the outlet section, means for measuring vibrations in a first direction and in a second direction, said means providing different signals in order to measure a wear characteristic of the nozzle, or a characteristic of the abrasive waterjet, or an alignment characteristic of the nozzle with an orifice; the monitoring process including the following steps: defining a benchmark of the abrasive waterjet cutting head by means of at least one of the first sensor and the second sensor; measuring a first data stream and a second data stream with the means for measuring vibrations; processing the first data stream and the second data stream in order to define a signature of the abrasive waterjet cutting head; comparing the signature to the benchmark; the abrasive waterjet cutting system being optionally in accordance with the invention.

Preferably, at step defining the benchmark comprises a fifth benchmark defined by means of the first sensor and a first computing module, optionally through a first mathematical operation, at step processing the signature comprises a fifth signature defined by means of the first data stream and the first computing module, and at step comparing the fifth signature is compared to the fifth benchmark.

Preferably, at step defining the benchmark comprises a sixth benchmark defined by means of the second sensor and a second computing module, optionally through a second mathematical operation; at step processing the signature comprises a sixth signature by means of the second data stream and the second computing module; and at step comparing the sixth signature is compared to the sixth benchmark.

Preferably, at step defining the benchmark comprises a seventh benchmark defined by means of a third mathematical operation on data from the first sensor and the second sensor, and at step processing the signature comprises a seventh signature defined by means of said third mathematical operation on the first data stream and the second data stream; at step comparing the seventh signature is compared to the seventh benchmark.

Preferably, the first mathematical operation and/or the second mathematical operation and/or the third mathematical operation may comprise at least one of: an addition, a multiplication, a division and a Fast Fourier Transform.

Preferably, at step defining the benchmark comprises a seventh benchmark defined by means of a mathematical operation on data stream from the first sensor and the second sensor, and at step processing the signature comprises a seventh signature defined by means of said mathematical operation on the first data stream and a second data stream; at step comparing the seventh signature is compared to the seventh benchmark.

Preferably, the process comprises a step computing a power spectral density from at least one of the upstream data stream, the downstream data stream; the first data stream and the second data stream; a step definition at least one frequency range in the power spectral density; a step identification of at least one peak; a step comparison of the identified peak with a reference peak a step computing the difference between the identified peak and the reference peak; a step providing a signal if the difference reaches or is higher than a predefined threshold.

Preferably the reference peak may be a benchmark.

Preferably, before step (b) defining a benchmark, the monitoring process may include a step (a) maintenance of the abrasive waterjet cutting head.

Preferably, the monitoring process may include a step (c) cutting a workpiece with the abrasive waterjet, the step (d) measuring may be performed during step (c) cutting.

Preferably, if the signature exceeds a tolerance with respect to the benchmark; the monitoring process may perform a step (g) producing at least one output signal which may be optionally used for controlling the abrasive waterjet cutting head, or optionally used for deciding a maintenance intervention.

Preferably, step (d) measuring may comprise measuring a pressure upstream the orifice, step (e) processing may comprise computing the static pressure and the dynamic pressure, optionally through Fourier Transform or Wavelet Transform, step (f) comparing may comprise the comparison of said Fourier Transform or Wavelet Transform to a first benchmark.

Preferably, the upstream sensor may comprise an upstream microphone and the downstream sensor may comprise a downstream microphone; during step (e) processing, a net signal may be calculated with the upstream data stream and the downstream data stream, said net signal may be optionally calculated by a decorrelation technique.

Preferably, the abrasive waterjet cutting system may include a workpiece sensor, optionally a piezo electric sensor, which may be fixed to the workpiece, during step (e) processing, the net signal may be calculated with the upstream data stream, the downstream data stream, and the data stream from the workpiece sensor, said net signal may optionally be calculated by a decorrelation technique.

Preferably, step (e) processing may comprise computation of Fourier Transform or Wavelet Transform of the net signal, said Fourier Transform or Wavelet Transform may be compared to a second benchmark during step (f) comparing.

Preferably, the upstream sensor may comprise an upstream accelerometer arranged at the inlet end of the nozzle and providing an inlet signal, step (e) processing may comprise the estimation of the

Fourier Transform or the Wavelet Transform of the inlet signal, said Fourier Transform or the Wavelet Transform may be compared to a third benchmark during step (f) comparing.

Preferably, the upstream sensor may comprise an upstream accelerometer, and the downstream sensor may comprise a downstream accelerometer, step (e) processing may comprise the calculation of a vibration transmissibility between the inlet end and the outlet end of the nozzle, said vibration transmissibility may be compared to a fourth benchmark during step (f) comparing.

Preferably, the monitoring process may control iteratively several conformity requirements with respective benchmarks.

Preferably, the abrasive waterjet cutting system may include a workpiece reception area in which the workpiece is fixed downstream the downstream sensor.

Preferably, during step (b) defining the benchmark may be computed using same processing as used for defining the signature during step (e) processing.

Preferably, the benchmark may be computed for different operating setpoints of the abrasive waterjet cutting head, step (b) defining comprising a training period.

Preferably, at step (f) comparing the signature may be compared against a benchmark corresponding to an instantaneous setpoint of step (c) cutting.

Preferably, during step (e) processing the downstream data stream may be divided by the upstream data stream.

Preferably, during step (e) processing the downstream data stream may be subtracted from the upstream data stream.

Preferably, during step (e) processing the upstream data stream and the downstream data stream may be measured at a same radial distance from the cutting abrasive waterjet. A radial distance may be measured perpendicularly to the waterjet.

Preferably, during step (f) comparing, the signature may be compared to a theorical benchmark.

Preferably, during step (c) cutting, the gap between the workpiece and the nozzle may remain constant.

Preferably, the or each Fourier transform, or the or each Wavelet Transform may be estimated using an Auto-Regressive-Moving-Average estimation of a raw signal.

Preferably, during step (d) measuring, the distance D2 may remain constant.

Preferably, during step (d) measuring may be continuous.

Preferably, step (e) processing may bean iterative processing, repeated at a regular time interval, said regular interval may range from 15 seconds to 25 seconds, on signals which may be windowed on that interval.

Preferably, in each set of sensors the downstream sensor may be nearer to the workpiece than the upstream sensor, and/or the upstream sensor may be nearer to the inlet end than the downstream sensor.

Preferably, step (f) comparing may compare the transmissibility to the fourth benchmark if the Fourier Transform or the Wavelet Transform of the upstream signal is consistent with the third benchmark; and/or the Fourier Transform or the Wavelet Transform of the upstream signal may be compare to the third benchmark third benchmark if the Fourier Transform or the Wavelet Transform of the net signal is consistent with the second benchmark; and/or the Fourier Transform or the Wavelet Transform of the net signal may be compared to the second benchmark if the upstream pressure is consistent with the first benchmark.

Preferably, step (b) defining a benchmark may be performed before step (c) cutting, and/or without workpiece.

Preferably, during step (a) maintenance, a new nozzle or a new orifice may be mounted in the abrasive waterjet cutting head, or the nozzle and the orifice may be realigned.

Preferably, the signature may be a vibroacoustic signature.

Preferably, the abrasive waterjet cutting system may comprise a nozzle area wherein the upstream sensor and the downstream sensor may be enclosed, the abrasive waterjet cutting system may further comprise a cutting area between the workpiece and the nozzle area, step (d) measuring may comprise measuring data stream with a second upstream sensor and a second downstream sensor within the cutting area.

Preferably, the upstream sensor and the downstream sensor may be distributed along the abrasive waterjet flow direction downstream the inlet end of the nozzle, and/or between the workpiece and the inlet end of the nozzle.

Preferably, during step (d) measuring and/or during step (b) defining, the abrasive waterjet may flow.

Preferably, at step (b) defining, the benchmark may be defined by the upstream sensor and the downstream sensor.

Preferably, step (b) defining and step (e) processing may comprise the same calculation steps.

Preferably, the signals may be synchronized.

It is another object of the invention to provide a monitoring process of an abrasive waterjet cutting system, the abrasive waterjet cutting system comprising:
an abrasive waterjet cutting head with an orifice, a nozzle guiding an abrasive waterjet, said nozzle including an inlet end and an outlet end;
an abrasive waterjet flow direction,
a monitoring device optionally adapted for measuring a wear characteristic of the nozzle, and/or a characteristic of the abrasive waterjet, and/or an alignment characteristic of the nozzle with an orifice;
   the monitoring process including the following steps: (c) cutting a workpiece with the abrasive waterjet;
(d) measuring an upstream data stream at an upstream location and a downstream data
stream at a downstream location, said location being between the workpiece and the inlet end of the nozzle;
(f) comparing the upstream data stream and the downstream data stream, eventually to each other, the abrasive waterjet cutting system being optionally in accordance with the invention.

Step (b) defining is not an essential aspect of the invention.

Step (e) processing is not an essential aspect of the invention.

It is another object of the invention to provide a computer comprising computer readable code means, which when run on a computer, cause the computer to run the monitoring process according to the invention.

It is another object of the invention to provide a computer program product including a computer readable medium on which the computer program according to the invention is stored.

It is another object of the invention to provide a computer configured for carrying out the monitoring process according to the invention.

The different objects of the invention may be combined to each other. The preferable options of each object may be applied to the other objects of the invention, unless the contrary is explicitly mentioned.

The features defined in relation with the upstream sensor and the downstream sensor may be generalized to the first sensor and the second sensor respectively, and to the means for measuring vibrations. The reciprocal also applies.

### ADVANTAGES OF THE INVENTION

A general understanding of the invention could be to measure one or several characteristic(s) of the system under conform conditions by one or two distant sensors, and then to monitor the characteristic(s) during cutting by the two sensors. With respect to the two microphones; one of the two microphones is used to clean the data of the other microphone in order to reduce the influence of the cutting condition on said other microphone.

The invention provides an AWJ system functioning with a couple of sensors which are arranged at different locations along the waterjet. At their distant locations, the sensors permit a differential measurement, and provide different signals which are compared to each other, and/or compared to a given precise benchmark. The provided monitoring improves the monitoring accuracy, and consequently the quality of the produced workpieces. Thus, a substantial economy may be obtained. Moreover, the accurate monitoring optimises the time during which a nozzle may still be used. Thus, the invention increases the lifetime of nozzle. The high accuracy, and the multiple signals obtained allows an exploitation during design studies of nozzle or other components, for better understanding of wear phenomena.

The pair of microphones, optionally in combination with the piezoelectric sensor, permits to isolate acoustic contribution of the waterjet from the acoustic contribution of environment, particularly the workpiece. Consequently, the invention provides relevant information of the cutting waterjet escaping the nozzle, and allows a detection of its features despite any disturbance from workpiece and/or environment.

The pair of accelerometers offers signals proper to the nozzle. The accelerometers may essentially be in contact of the nozzle in order to reduce the influence of its supports, or the frame of the AWJ system. Consequently, the obtained vibration transmissibility becomes more relevant and the wear state may be assessed more precisely.

The invention is of first interest since it provides monitoring data during the cutting operation.

Thus, the monitoring task does not stop the production and does not impact the manufacturing costs. In addition, the invention provides a better understanding of the AWJ system state, and reduces the computing resources which are required for attaining a given level of accuracy.

### BRIEF DESCRIPTION OF THE DRAWINGS

Several embodiments of the present invention are illustrated by way of figures, which do not limit the scope of the invention, wherein:

FIG. 1 provides a schematic illustration of a cut through an AWJ system in accordance with a first preferred embodiment of the invention;

FIG. 2 provides a schematic illustration of a cut through an AWJ system in accordance with a second preferred embodiment of the invention;

FIG. 3 provides a schematic illustration of a cut through an AWJ system in accordance with a third preferred embodiment of the invention;

FIG. 4 provides a schematic illustration of a nozzle in accordance with a first preferred embodiment of the invention;

FIG. 5 provides a schematic illustration of a nozzle in accordance with a second preferred embodiment of the invention;

FIG. 6 provides a schematic illustration of a nozzle in accordance with a third preferred embodiment of the invention;

FIG. 7 provides a schematic illustration of a nozzle in accordance with a fourth preferred embodiment of the invention;

FIG. 8 provides a schematic illustration of a monitoring process in accordance with a preferred embodiment of the invention;

FIG. 9 provides a graph of the power spectral density of an AWJ in accordance with the invention;

FIG. 10 provides a peak shift in amplitude of a power spectral density in accordance with the invention;

FIG. 11 provides a peak shift in frequency of a power spectral density in accordance with the invention.

### DETAILED DESCRIPTION OF THE INVENTION

This section describes the invention in further details based on preferred embodiments and on the figures. Identical reference numbers will be used to describe similar or the same concepts throughout different embodiments of the invention.

It should be noted that features described for a specific embodiment described herein may be combined with the features of other embodiments unless the contrary is explicitly mentioned.

Features commonly known in the art will not be explicitly mentioned for the sake of focusing on the features that are specific to the invention. For example, the abrasive waterjet cutting system in accordance with the invention is evidently powered by an electric supply and pump system, even though such supply is not explicitly referenced on the figures nor referenced in the description.

In the following description, the words “downstream” and “upstream” are considered in relation with the abrasive waterjet flow direction. These words also apply before the abrasive waterjet flow starts, and after the workpiece.

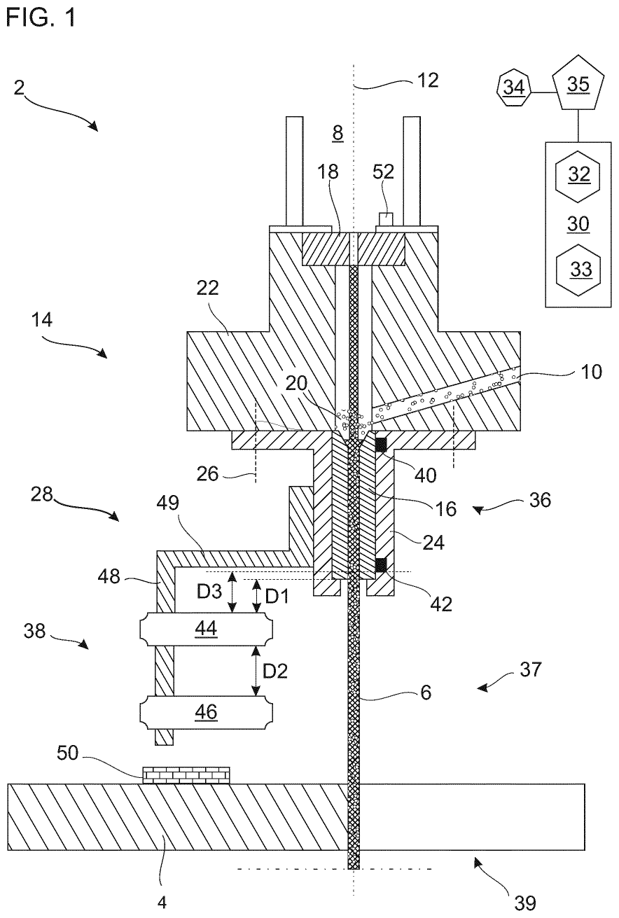

FIG. 1 shows a cross section of an abrasive waterjet cutting system 2 in accordance with a first embodiment of the invention. The abrasive waterjet cutting system 2 is represented above a workpiece 4 which is currently cut by the abrasive cutting waterjet 6. The current cross section is taken along the cut-out of the workpiece 4 which is represented with hatchings before the kerf, and which is hatching free on the kerf created by the abrasive cutting waterjet 6. Despite the workpiece 4 is represented under the abrasive waterjet cutting system 2, it is encompassed in the current invention any other orientation. For instance, the workpiece 4 may be beside the abrasive waterjet cutting system 2, and the abrasive cutting waterjet 6 may flow horizontally.

The abrasive waterjet cutting system 2 may include a high-pressure fluid source 8, notably a high-pressure water source or high-pressure water vessel. In the current figure, the high-pressure fluid source 8 is arbitrarily cut and may extend further upstream. Similarly, the cutting abrasive waterjet 6 is arbitrarily interrupted downstream the workpiece 4 for representation purpose, and may flow further downstream, notably in a through cut configuration. The high-pressure fluid source 8 is adapted for providing the fluid at a pressure ranging from 2500 bars to 6900 bars. For instance, the fluid pressure is about 4000 bars. The abrasive waterjet cutting system 2 may also comprise an abrasive particle supply 10.

The abrasive waterjet cutting system 2 exhibits an abrasive waterjet flow direction 12 and an abrasive waterjet cutting head 14 with a nozzle 16 adapted for guiding the abrasive waterjet 6 along the abrasive waterjet flow direction 12, and adapted for transferring momentum from fluid to particles. The nozzle 16 is also known as a “focussing tube”.

The abrasive waterjet flow direction 12 may be considered as a geometrical axis. It is directed from the abrasive waterjet (AWJ) cutting head 14 toward the workpiece 4. It projects beyond the workpiece 4 and the abrasive waterjet cutting system 2. It may be colinear with the abrasive cutting waterjet 6.

An orifice 18 may be in fluid communication with the high-pressure fluid source 8. It may guide a high-speed waterjet toward the nozzle 16. Upstream the orifice 18, water may have a high-pressure, and downstream the orifice 18 it may have a high-speed. The high-speed water jet may be a single-phase water jet. The high-speed water jet may accelerate the abrasive particles received in a mixing chamber 20. More precisely, the acceleration of particles is provided by momentum transfer with the high-speed water jet, and the momentum transfer may essentially take place in the nozzle 16.

The abrasive waterjet cutting system 2 may be adapted such that the abrasive cutting waterjet 6 reaches a speed in the range of 300 -1200 m/s downstream the nozzle 16. The abrasive cutting waterjet 6 may be a three phases waterjet, and may include water, air and particles in suspension.

The abrasive waterjet cutting head 14 may include a main support 22. The main support 22 may bear the orifice 18, and/or may be in contact with the high-pressure fluid source 8. The mixing chamber 20 may be formed therein. The abrasive particle supply 10 may cross it.

The abrasive waterjet cutting head 14 may comprise a casing 24 supporting the nozzle 16. The casing 24 may encapsulate the nozzle 16. The casing 24 may form a sleeve surrounding the nozzle 16. The casing 24 may be colinear with the abrasive waterjet flow direction 12. The casing 24 may be in contact of the main support 22. It may be fixed thereon, notably by reversible fixation means 26 such as screws. These reversible fixation means 26 permit a fast access to the nozzle 16 in order to replace it, for instance during a maintenance operation requiring a nozzle replacement subsequently to an excessive wear state detection.

In order to assess the functioning of the abrasive waterjet cutting system 2, a monitoring device 28 is provided. The latter is adapted for measuring at least one wear characteristic or the wear characteristics of the nozzle 16, and/or at least one characteristic of the abrasive waterjet 6 or the characteristics of the abrasive waterjet 6, or at least one alignment characteristic or the alignment characteristics of the nozzle 16 with the orifice 18. The abrasive jet characteristic may be a feature strictly depending on the acoustic pressure it generates and can be related to the quality of the cut it produces. In other words,: the sound generated by the waterjet is measured, therefrom a feature is extracted, and according to that feature it may be monitored whether the cut is good or compromised.

The monitoring device 28 may be connected to a computer 30 in order to process signals. More precisely, the computer 30 may include a computer readable medium 32 on which a computer program is stored, and a central processing unit (CPU) 33 which is adapted for carrying out the instructions of the computer program. The monitoring device 28 may include a preamplifier 34 connected to the computer 30, and amplifying electric signals from sensors, notably the sensors as set forth below. An acquisition board 35 with an A/D converter may connect the preamplifier 34 to the computer 30.

The monitoring device 28 includes at least one set of sensors. The monitoring device 28 may include two sets of sensors, with a first set 36 of sensors and a second set of sensors 38. These sets of sensors may be an upstream set 36 of sensors associated to the nozzle, and a downstream set 38 of sensors arranged in the cutting area 37 between the nozzle 16 and the workpiece 4. Each set of sensors may consist in a pair of sensors. In each set, the sensors may be at distance with respect to the abrasive waterjet 6, or to the axis formed by the former.

The abrasive waterjet cutting system 2 may exhibit a workpiece reception area 39. The workpiece reception area 39 may enclose fixation elements (not represented) for fixing the workpiece 4 to the framework of the system 2.

The upstream set 36 may include accelerometers (40; 42), notably an upstream accelerometer 40 and a downstream accelerometer 42. The accelerometers (40; 42) may be fixed to the nozzle 16; for instance by gluing or by screws (not represented) engaging the casing 24. The accelerometers (40; 42) may be disposed in the thickness of the casing 24.

The signal from the upstream accelerometer 40 may be correlated to the conditions under which the pure waterjet from the orifice 18 impinges the inlet section of the nozzle 16. Data processing performed by the computer 30 enables a misalignment detection between the orifice 18 and the facing nozzle 16. Computing the signals of both accelerometers (40; 42) allows at least to measure the nozzle wear.

The accelerometers (40; 42) may be nano-accelerometers. The accelerometers (40; 42) may be three dimensional accelerometers, which are adapted for measuring accelerations and thus vibrations of the nozzle 16 in three perpendicular directions.

The downstream set 38 may include microphones (44; 46), notably an upstream microphone 44 and a downstream microphone 46. At this location, the microphones (44; 46) are sensitive to the sound produced by the workpiece 4. Within the corresponding set, the upstream microphone 44 is the nearest from the nozzle outlet whereas the downstream microphone 46 is the nearest from the workpiece 4.

These microphones (44; 46) are arranged between the lower end of the casing 24 and the upper face of the workpiece 4. Thus, the microphones (44; 46) may be arranged in the cutting area 37.

The microphones (44; 46) are adapted for measuring acoustic pressure downstream the abrasive waterjet cutting head 14, and in turn for measuring sound generated by the abrasive cutting waterjet 6 which permits to obtain a jet characteristic.

The abrasive waterjet cutting system 2 may include a frame 48. The frame 48 receives the upstream microphone 44 and the downstream microphone 46. The frame 48 may include a transversal portion 49. This transversal portion 49 may project perpendicularly from the abrasive waterjet flow direction 12, and/or from the abrasive cutting waterjet 6. The transversal portion 49 permits to set a fixed distance between the microphones and the abrasive cutting waterjet 6.

The frame 48 is adapted for maintaining a constant distance D2 between the microphones (44; 46).

This distance D2 may be larger than a distance D1 between the outlet end of the nozzle 16 and the upstream microphone 44. This means that, along the abrasive waterjet flow direction 12, the upstream microphone 44 may be closer to the nozzle 16 than to the downstream microphone 46.

As apparent from FIG. 1, the set 36 of accelerometers (40; 42) and the set 38 of microphones (44; 46) may be distant and distinct. They may be geometrically separated with respect to the abrasive waterjet flow direction 12. Indeed, there may be a distance D3 between the sets of sensors. The distance D3 may also be set by the frame 48.

The distances (D1; D2; D3) may be considered along the abrasive waterjet flow direction 12.

The abrasive waterjet cutting system 2 may comprise a workpiece sensor, notably a piezoelectric sensor 50. The piezoelectric sensor 50 may be added to the abrasive waterjet cutting system 2. The piezoelectric sensor 50 is adapted for measuring vibrations. It may be associated with the workpiece 4, and may notably be fixed thereon on the face in front of the abrasive waterjet cutting head 14. In this configuration, the piezoelectric sensor 50 permits to sense vibrations generated and/or borne by the workpiece 4; notably in response to the cutting operation of the abrasive cutting waterjet 6.

The abrasive waterjet cutting system 2 may enclose an orifice sensor 52. The orifice sensor 52 may be upstream the orifice 18. The position in the current figure is merely illustrative. The orifice sensor 52 is structurally and functionally adapted for measuring the fluid pressure upstream the orifice 18. The orifice sensor 52 may be a strain gauge sensor, for instance adapted for measuring pressure applied on its support. The pressure upstream the orifice 18 may then be estimated, notably in order to estimate the orifice wear.

As a further embodiment, the abrasive waterjet cutting system comprises two vibration sensors.

The sensors along the nozzle 16 and the cutting space comprise an accelerometer sensor and a microphone sensor. The sensors are of different nature. The abrasive waterjet cutting system may combine the upstream accelerometer 40 and one of the microphones 44 or 46. As an alternative the abrasive waterjet cutting system combines the downstream accelerometer 42 and one of the microphones 44 or 46.

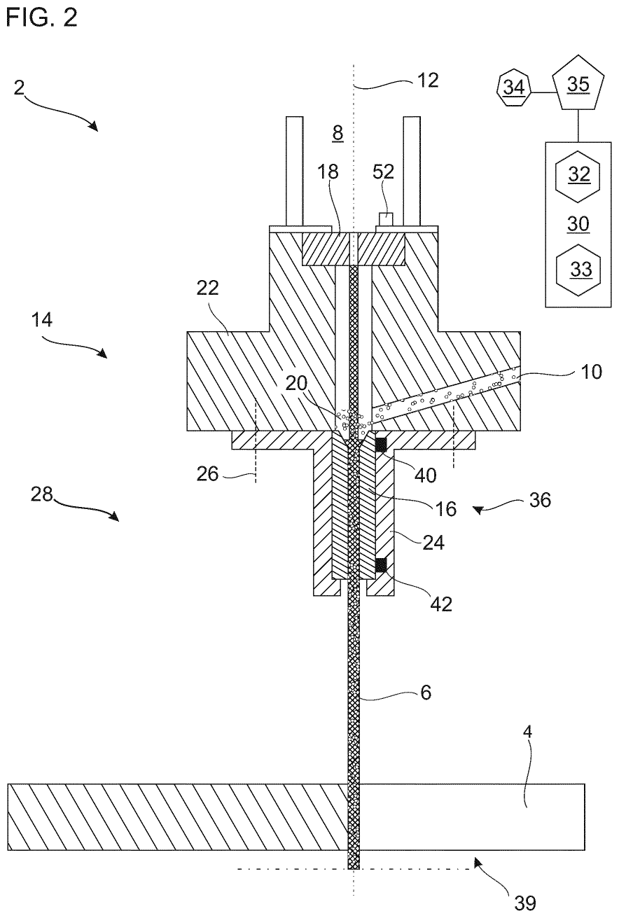

FIG. 2 shows a cross section of an abrasive waterjet cutting system 2 in accordance with a second embodiment of the invention. The second embodiment of the invention is substantially similar to the first embodiment. The second embodiment is essentially free of the microphones which have been previously presented.

The abrasive waterjet cutting system 2 is represented above a workpiece 4 which is currently cut by the abrasive cutting waterjet 6. The current cross section is taken along the cut-out of the workpiece 4 which is represented with hatchings before the kerf, and which is hatching free on the kerf created by the abrasive cutting waterjet 6. Despite the workpiece 4 is represented under the abrasive waterjet cutting system 2, it is encompassed in the current invention any other orientation.

For instance, the workpiece 4 may be beside the abrasive waterjet cutting system 2, and the abrasive cutting waterjet 6 may flow horizontally.

The abrasive waterjet cutting system 2 may include a high-pressure fluid source 8, notably a high-pressure water source or high-pressure water vessel. In the current figure, the high-pressure fluid source 8 is arbitrarily cut and may extend further upstream. Similarly, the cutting abrasive waterjet 6 is arbitrarily interrupted downstream the workpiece 4 for representation purpose, and may flow further downstream, notably in a through cut configuration. The high-pressure fluid source 8 is adapted for providing the fluid at a pressure ranging from 2500 bars to 6900 bars. For instance, the fluid pressure is about 4000 bars. The abrasive waterjet cutting system 2 may also comprise an abrasive particle supply 10.

The abrasive waterjet cutting system 2 exhibits an abrasive waterjet flow direction 12 and an abrasive waterjet cutting head 14 with a nozzle 16 adapted for guiding the abrasive waterjet 6 along the abrasive waterjet flow direction 12 and transferring momentum from fluid to particles. The nozzle 16 is also known as a “focussing tube”.

The abrasive waterjet flow direction 12 may be considered as a geometrical axis. It is directed from the abrasive waterjet cutting head 14 toward the workpiece 4. It projects beyond the workpiece 4 and the abrasive waterjet cutting system 2. It may be colinear with the abrasive cutting waterjet 6.

An orifice 18 may be in fluid communication with the high-pressure fluid source 8. It may guide a high-speed waterjet toward the nozzle 16. Upstream the orifice 18, water may have a high-pressure, and downstream the orifice 18 it may have a high-speed. The high-speed water jet may be a single-phase water jet. The high-speed water jet may accelerate the abrasive particles received in a mixing chamber 20. More precisely, the acceleration of particles is provided by momentum transfer with the high-speed water jet, and the momentum transfer may essentially take place in the nozzle 16.

The abrasive waterjet cutting system 2 may be adapted such that the abrasive cutting waterjet 6 reaches a speed in the range of 300-1200 m/s downstream the nozzle 16. The abrasive cutting waterjet 6 may be a three phases waterjet, and may include water, air and particles in suspension.

The abrasive waterjet cutting head 14 may include a main support 22. The main support 22 may bear the orifice 18, and/or may be in contact with the high-pressure fluid source 8. The mixing chamber 20 may be formed therein. The abrasive particle supply 10 may cross it.

The abrasive waterjet cutting head 14 may comprise a casing 24 supporting the nozzle 16. The casing 24 may encapsulate the nozzle 16. The casing 24 may form a sleeve surrounding the nozzle 16. The casing 24 may be colinear with the abrasive waterjet flow direction 12. The casing 24 may be in contact of the main support 22. It may be fixed thereon, notably by reversible fixation means 26 such as screws. These reversible fixation means 26 permit a fast access to the nozzle 16 in order to replace it, for instance during a maintenance operation requiring a nozzle replacement subsequently to an excessive wear state detection.

In order to assess the functioning of the abrasive waterjet cutting system 2, a monitoring device 28 is provided. The latter is adapted for measuring at least one wear characteristic or the wear characteristics of the nozzle 16, or at least one alignment characteristic or the alignment characteristics of the nozzle 16 with the orifice 18. The abrasive jet characteristic may be a feature strictly depending on the acoustic pressure it generates and can be related to the quality of the cut it produces. In other words: the sound generated by the waterjet is measured, from a feature is extracted, and according to that feature it may be monitored whether the cut is good or compromised.

The monitoring device 28 may be connected to a computer 30 in order to process signals. More precisely, the computer 30 may include a computer readable medium 32 on which a computer program is stored, and a central processing unit (CPU) 33 which is adapted for carrying out the instructions of the computer program. The monitoring device 28 may include a preamplifier 34 connected to the computer 30, and amplifying electric signals from sensors, notably the sensors as set forth below. An acquisition board 35 with an A/D converter may connect the preamplifier 34 to the computer 30.

The abrasive waterjet cutting system 2 may exhibit a workpiece reception area 39. The workpiece reception area 39 may enclose fixation elements (not represented) for fixing the workpiece 4 to the framework of the system 2.

An upstream set 36 of sensors may include accelerometers (40; 42), notably an upstream accelerometer 40 and a downstream accelerometer 42. The accelerometers (40; 42) may be fixed against the nozzle 16; for instance, by gluing or by screws (not represented) engaging the casing 24. The accelerometers (40; 42) may be disposed in the thickness of the casing 24.

The signal from the upstream accelerometer 40 may be correlated to the conditions under which the pure waterjet from the orifice 18 impinges the inlet section of the nozzle 16. Data processing performed by the computer 30 enables a misalignment detection between the orifice 18 and the facing nozzle 16. Computing the signals of both accelerometers (40; 42) allows at least to measure the nozzle wear.

The accelerometers (40; 42) may be nano-accelerometers. The accelerometers (40; 42) may be three dimensional accelerometers, which are adapted for measuring accelerations and thus vibrations of the nozzle 16 in three perpendicular directions.

The abrasive waterjet cutting system 2 may enclose an orifice sensor 52. The orifice sensor 52 may be upstream the orifice 18. The position in the current figure is merely illustrative. The orifice sensor 52 is structurally and functionally adapted for measuring the fluid pressure upstream the orifice 18. The orifice sensor 52 may be a strain gauge sensor, for instance adapted for measuring pressure applied on its support. The pressure upstream the orifice 18 may then be estimated, notably in order to estimate the orifice wear.

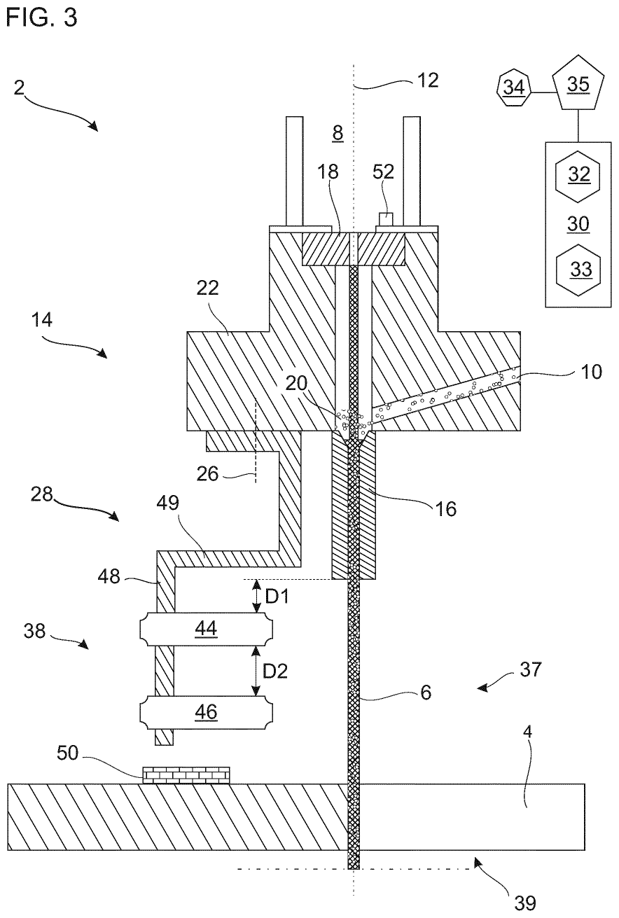

FIG. 3 shows a cross section of an abrasive waterjet cutting system 2 in accordance with a third embodiment of the invention. The third embodiment of the invention is substantially similar to the first embodiment. The third embodiment is essentially free of the accelerometers which have been previously presented.

The abrasive waterjet cutting system 2 is represented above a workpiece 4 which is currently cut by the abrasive cutting waterjet 6. The current cross section is taken along the cut-out of the workpiece 4 which is represented with hatchings before the kerf, and which is hatching free on the kerf created by the abrasive cutting waterjet 6. Despite the workpiece 4 is represented under the abrasive waterjet cutting system 2, it is encompassed in the current invention any other orientation.

For instance, the workpiece 4 may be beside the abrasive waterjet cutting system 2, and the abrasive cutting waterjet 6 may flow horizontally.

The abrasive waterjet cutting system 2 may include a high-pressure fluid source 8, notably a high-pressure water source or high-pressure water vessel. In the current figure, the high-pressure fluid source 8 is arbitrarily cut and may extend further upstream. Similarly, the cutting abrasive waterjet 6 is arbitrarily interrupted downstream the workpiece 4 for representation purpose, and may flow further downstream, notably in a through cut configuration. The high-pressure fluid source 8 is adapted for providing the fluid at a pressure ranging from 2500 bars to 6900 bars. For instance, the fluid pressure is about 4000 bars. The abrasive waterjet cutting system 2 may also comprise an abrasive particle supply 10.

The abrasive waterjet cutting system 2 exhibits an abrasive waterjet flow direction 12 and an abrasive waterjet cutting head 14 with a nozzle 16 adapted for guiding the abrasive waterjet 6 along the abrasive waterjet flow direction 12 and transferring momentum from fluid to particles. The nozzle 16 is also known as a “focussing tube”.

The abrasive waterjet flow direction 12 may be considered as a geometrical axis. It is directed from the abrasive waterjet cutting head 14 toward the workpiece 4. It projects beyond the workpiece 4 and the abrasive waterjet cutting system 2. It may be colinear with the abrasive cutting waterjet 6.

An orifice 18 may be in fluid communication with the high-pressure fluid source 8. It may guide a high-speed waterjet toward the nozzle 16. Upstream the orifice 18, water may have a high-pressure, and downstream the orifice 18 it may have a high-speed. The high-speed water jet may be a single-phase water jet. The high-speed water jet may accelerate the abrasive particles received in a mixing chamber 20. More precisely, the acceleration of particles is provided by momentum transfer with the high-speed water jet, and the momentum transfer may essentially take place in the nozzle 16.

The abrasive waterjet cutting system 2 may be adapted such that the abrasive cutting waterjet 6 reaches a speed in the range of 300-1200 m/s downstream the nozzle 16. The abrasive cutting waterjet 6 may be a three phases waterjet, and may include water, air and particles in suspension.

The abrasive waterjet cutting head 14 may include a main support 22. The main support 22 may bear the orifice 18, and/or may be in contact with the high-pressure fluid source 8. The mixing chamber 20 may be formed therein. The abrasive particle supply 10 may cross it.

In order to assess the functioning of the abrasive waterjet cutting system 2, a monitoring device 28 is provided. The latter is adapted for monitoring at least one characteristic of the abrasive waterjet 6 or the characteristics of the abrasive waterjet 6. The abrasive jet characteristic may be a feature strictly depending on the acoustic pressure it generates and can be related to the quality of the cut it produces. In other words: the sound generated by the waterjet is measured, from a feature is extracted, and according to that feature it may be monitored whether the cut is good or compromised.

The monitoring device 28 may be connected to a computer 30 in order to process signals. More precisely, the computer 30 may include a computer readable medium 32 on which a computer program is stored, and a central processing unit (CPU) 33 which is adapted for carrying out the instructions of the computer program. The monitoring device 28 may include a preamplifier 34 connected to the computer 30, and amplifying electric signals from sensors, notably the sensors as set forth below. An acquisition board 35 with an A/D converter may connect the preamplifier 34 to the computer 30.

The abrasive waterjet cutting system 2 may exhibit a workpiece reception area 39. The workpiece reception area 39 may enclose fixation elements (not represented) for fixing the workpiece 4 to the framework of the system 2.

A downstream set 38 of sensors may include microphones (44; 46), notably an upstream microphone 44 and a downstream microphone 46. At this location, the microphones (44; 46) are sensitive to the sound produced by the workpiece 4. Within the corresponding set, the upstream microphone 44 is the nearest from the nozzle outlet whereas the downstream microphone 46 is the nearest from the workpiece 4.

These microphones (44; 46) are arranged between the lower end of the nozzle 16 and the upper face of the workpiece 4. Thus, the microphones (44; 46) may be arranged in the cutting area 37.

The microphones (44; 46) are adapted for measuring acoustic pressure downstream the abrasive waterjet cutting head 14, and in turn for measuring sound generated by the abrasive cutting waterjet 6 which permits to obtain a jet characteristic.

The abrasive waterjet cutting system 2 may include a frame 48. The frame 48 receives the upstream microphone 44 and the downstream microphone 46. The frame 48 may include a transversal portion 49. This transversal portion 49 may project perpendicularly from the abrasive waterjet flow direction 12, and/or from the abrasive cutting waterjet 6. The transversal portion 49 permits to set a fixed distance between the microphones and the abrasive cutting waterjet 6.

The frame 48 may be fixed to the main casing 22 by means of reversible fixation means 26, which indirectly permit to fix the upstream microphone 44 and the downstream microphone 46 to the main casing 22.

The frame 48 is adapted for maintaining a constant distance D2 between the microphones (44; 46).

This distance D2 may be larger than a distance D1 between the outlet end of the nozzle 16 and the upstream microphone 44. This means that, along the abrasive waterjet flow direction 12, the upstream microphone 44 may closer to the nozzle 16 than to the downstream microphone 46.

The distances (D1; D2) may be considered along the abrasive waterjet flow direction 12.

The abrasive waterjet cutting system 2 may comprise a workpiece sensor, notably a piezoelectric sensor 50. The piezoelectric sensor 50 may be added to the abrasive waterjet cutting system 2. The piezoelectric sensor 50 is adapted for measuring vibrations. It may be associated with the workpiece 4, and may notably be fixed thereon on the face in front of the abrasive waterjet cutting head 14. In this configuration, the piezoelectric sensor 50 permits to sense vibrations generated and/or borne by the workpiece 4; notably in response to the cutting operation of the abrasive cutting waterjet 6.

The abrasive waterjet cutting system 2 may enclose an orifice sensor 52. The orifice sensor 52 may be upstream the orifice 18. The position in the current figure is merely illustrative. The orifice sensor 52 is structurally and functionally adapted for measuring the fluid pressure upstream the orifice 18. The orifice sensor 52 may be a strain gauge sensor, for instance adapted for measuring pressure applied on its support. The pressure upstream the orifice 18 may then be estimated, notably in order to estimate the orifice wear.

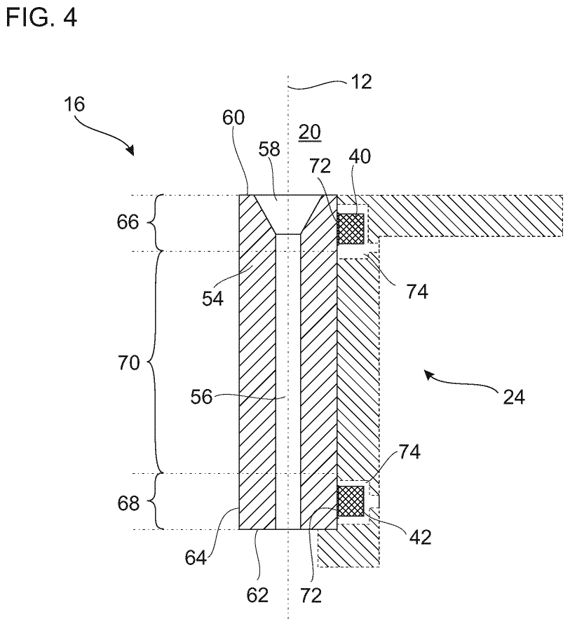

FIG. 4 shows a nozzle 16 for an abrasive waterjet cutting system, for instance an abrasive waterjet cutting system similar or identical to the ones described in relation with FIGS. 1 to 3. The nozzles of FIGS. 1 to 4 may be similar or identical. For the sake of clarity, only a portion of the casing 24 is represented with dotted lines.

The nozzle 16 essentially comprises a tubular body 54. In order to resist to abrasion and erosion from abrasive particles, the body 54 may be formed from of an essentially hard material. Tungsten carbide may be used. The body 54 may generally comprise metal. It may be integrally formed. It may be one-piece. The nozzle 16 may exhibit a passage 56 through the tubular body 54, for instance a straight passage. The passage 56 may be colinear with the abrasive waterjet flow direction 12. In the current view, the passage 56 is arranged vertically. The passage 56 may present a conical portion forming a hoper 58 communicating with the mixing chamber 20.

The nozzle 16 exhibits an inlet end 60 and an outlet end 62 which are disposed upstream and downstream respectively, and which are joined by the cylindrical outer surface 64 of the nozzle 16.

The nozzle 16 exhibits two opposite end sections, notably an upstream section 66 and a downstream section 68, in contact of the inlet end 60 and of the outlet end 62 respectively. Each section may project along at most: 20%, or 10%, of the length of the nozzle 16. These sections (66; 68) may be separated by a central section 70, which may extend along the majority of the nozzle length, for instance along at least: 70%, or 80% of the nozzle 16. The central section 70 may be sensor free. The length may be measured along the abrasive waterjet flow direction 12.

The upstream section 66 and the downstream section 68 may both receive a sensor, notably an upstream sensor or a downstream sensor. The sensors may be in contact of the cylindrical outer surface 64. Each sensor may be centred with respect to the corresponding section (66; 68). These sensors may correspond to the upstream accelerometer 40 and to the downstream accelerometer 42.

The sensors may be held in position by screws (not represented) engaging the casing 24.

Alternatively, or in addition; the sensors may be held by adhesive 72 at the interface with the cylindrical outer surface 64.

The casing 24 may exhibit pockets 74, for instance an upstream pocket and a downstream pocket receiving the upstream accelerometer 40 and the downstream accelerometer 42 respectively. The pockets 74 may be open on the nozzle 16. They may also exhibit apertures at the opposite for wirings (not represented). The inner surfaces of the pockets 74 may be distant from the sensors.

Consequently, the pockets 74 may be free of contact with the sensors in order to not interfere with their measurements.

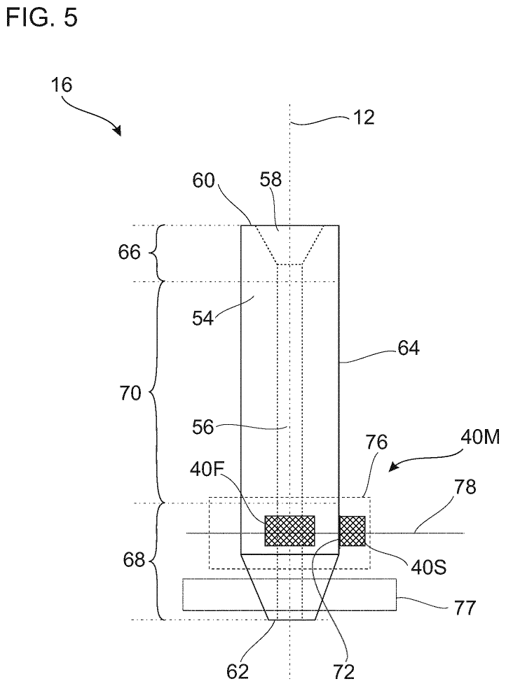

FIG. 5 shows a nozzle 16 for an abrasive waterjet cutting system, for instance an abrasive waterjet cutting system similar or identical to the ones described in relation with FIGS. 1 to 4.

The nozzle 16 generally comprises a tubular body 54. The shape of the body is essentially cylindrical. The body 54 may exhibit a hexagonal portion. As an alternative, the hexagonal portion is replaced by any other shape at the inlet section. Said other shape may ease installation and clamping. In order to resist to abrasion and erosion from abrasive particles, the body 54 may be formed from of an essentially hard material.

The passage 56 may be colinear with the abrasive waterjet flow direction 12. In the current view, the passage 56 is arranged vertically. The passage 56 may present a conical portion forming a hoper 58. The nozzle 16 exhibits an inlet end 60 and an outlet end 62 which are disposed upstream and downstream respectively, and which are joined by the cylindrical outer surface 64 of the nozzle 16. The outlet end 62 comprises a cylindrical surface and possibly a conical surface.

The nozzle 16 exhibits two opposite end sections, notably an upstream section 66 and a downstream section 68, adjacent of the inlet end 60 and of the outlet end 62 respectively. The downstream section 68 may comprise at least one flat surface, also designated as facet, for receiving accelerometer sensors. The downstream section 68 extends at most on the half of the body. As an option, each section extends along at most: 35% or 20%, or 10%, of the length of the nozzle 16. These sections (66; 68) may be separated by a central section 70, which may extend along the majority of the nozzle length, for instance along at least: 70%, or 80% of the nozzle 16.

The central section 70 may be sensor free. The length may be measured along the abrasive waterjet flow direction 12. The upper half of the nozzle may be sensor free, notably accelerometer sensor free.

The downstream section 68 receives means 40M for sensing vibrations in at least two directions which are transversal to the flow direction 12. The means 40M are configured for sensing vibrations of the nozzle outlet section in the two or more directions. Two of said directions are transversal with respect to each other, and with respect to the flow direction 12. As an option, these three directions are perpendicular to each other.

The means 40M may comprise a first sensor 40F and a second sensor 40S. Each of them is adapted for sensing vibrations in one the two directions, and to provide a corresponding signal. Each of the signals is representative of one direction. The sensors 40F and 40S may be in contact of the cylindrical outer surface 64, for instance of the flat surfaces. Alternatively, or in addition; the sensors may be held by adhesive 72 at the interface with the cylindrical outer surface 64. As a further alternative, screws may be used. The latter may be arranged at the flat surfaces.

As a further alternative, the sensors 40F and 40S are mounted on the nozzle 16 by means of an adaptor 76 (represented in dotted lines). The sensors 40F and 40S may fixed to the adaptor 76 by means of adhesive or screws. The adaptor 76 may be a plate with a through hole crossed by the nozzle 16, and notably the body 54. The sensors 40F and 40S are held at distance by the adaptor 76. As an alternative, the adaptor 76 may have any other shape, such as a prism.

The adaptor 76 may form or comprise a shield 77 protecting the sensors 40F and 40S. It exhibits a thickness of material between the means 40M, notably each sensors 40F and 40S, and the outlet end 62. The shield 77 may be at distance from the adaptor 76. The shield 77 may be downstream the adaptor 76. It may form a plate spanning under the sensors. Thus, there is a protection against projections from the abrasive waterjet. The lifecycle of the means 40M is longer and may support the cutting conditions of the nozzle during the whole life of the latter. As an option, the means 40M may be reused over several nozzles 16.

The sensors 40F and 40S are disposed at a same level. Along the flow direction 12, they are at a same location. They are at a same distance from the outlet end 62. The nozzle 16 comprises a geometry plan 78. The geometrical plan 78 may correspond to a fictious planar surface. The geometry plan 78 is perpendicular to the flow direction 12 and crosses the sensors 40F and 40S.

As an alternative, the sensors 40F and 40S are replaced by a multidirectional sensor (not represented).

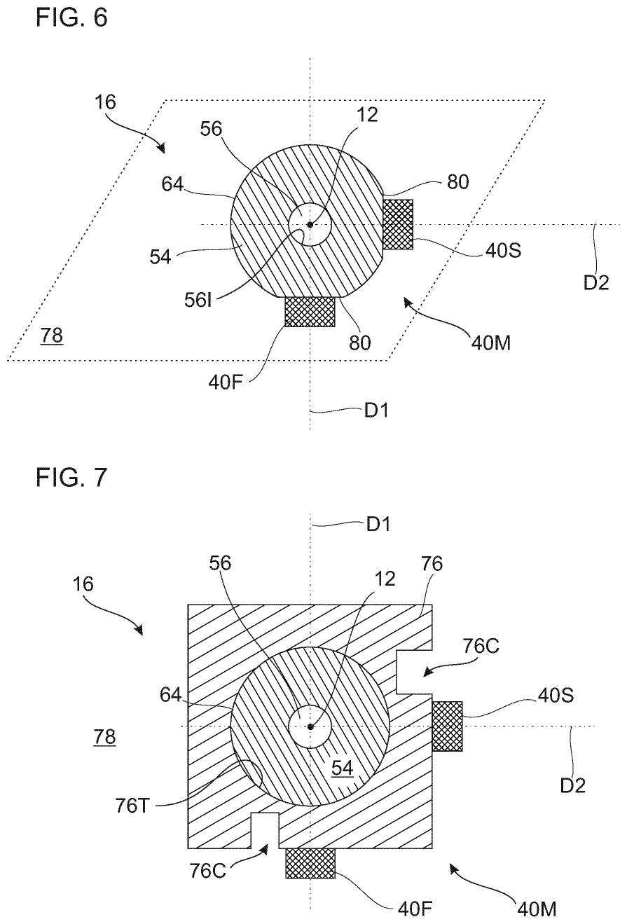

FIG. 6 shows a section of a nozzle 16 for an abrasive waterjet cutting system, for instance an abrasive waterjet cutting system similar or identical to the ones described in relation with FIGS. 1 to 5. The section of the nozzle 16 is perpendicular to the flow direction 12. For instance, the section is through the geometry plan 78. The geometry plan 78 may be defined by the first direction D1 and the second direction D2. The current figure exposes the inner surface 561 of the nozzle 56, which forms an element in contact and guiding the abrasive waterjet. The element resists to particle abrasion in the context of high pressure, for instance with a pressure above 1000 bars.

The nozzle 16 comprises the means 40M for measuring vibrations along the first direction D1 and the second direction D2. The means 40M comprise a first vibration sensor 40F sensing vibrations in the first direction D1, and a second sensor 40S sensing vibrations in the second direction D2.

The sensors 40F and 40S are distributed around the passage 56. They are angularly distant about the flow direction 12. These sensors may be accelerometers, for instance unidirectional accelerometers. They provide different signals, each corresponding to directions inclined with respect to the flow direction 12. As an alternative, the unidirectional accelerometers are replaced by one multidirectional accelerometer, for instance a bidirectional or a three-dimensional accelerometer.

The nozzle 16 essentially comprises a circular body 54. It essentially exhibits a circular outline generating it outer surface 64. The nozzle 16 comprises at least one facet 80 receiving the means 40M. The facets 80 are perpendicular to the first direction D1 and the second directions D2 and each receive one of the sensors 40F and 40S. They are along the flow direction 12. The facets 80 are formed on a section of the nozzle, or on its whole height.

Offering facets 80 improves the positioning of the means 40M. Thus, the arrangement is more robust, the obtained data is more relevant. Since the sensors are at a known and predefined positions, the behaviour of the abrasive waterjet cutting system is controlled with an improved accuracy.

The arrangement of the sensors in a shifted arrangement allows measurement in different directions. Thus, more information is available for monitoring, and more cutting configurations may be detected.

The sensors 40F and 40S are used for defining the so called: fifth benchmark, fifth signature, sixth benchmark, sixth signature, seventh benchmark and seventh signature. The fifth benchmark and the fifth signature may be defined by measurements along the first direction D1. The sixth benchmark and the sixth signature may be defined by measurements along the second direction D2.

The seventh benchmark and the seventh signature may be obtained by combining the fifths and sixth counterparts. The seventh benchmark and the seventh signature may be computed by multiplying or dividing or more generally comparing the values obtained from the sensors 40F and 40S.

FIG. 7 shows a section of a nozzle 16 for an abrasive waterjet cutting system, for instance an abrasive waterjet cutting system similar or identical to the ones described in relation with FIGS. 1 to 6. The section may be through the geometry plan 78 as represented in FIG. 5.

The nozzle 16 comprises the adaptor 76. The adaptor 76 is around the body 54 of the nozzle 16.

The adaptor 76 comprises a plate which is rectangular or square. The adaptor 76 may exhibit any other shape; such as a prims shape. It presents a central through hole 76T mating with the cylindrical outer surface 64. The through hole 76T is colinear with the passage 56. The adaptor 76 comprises at least one cavity such as a side cavity 76C. The cavities 76C are angled at 90° or other angle around the passage 56. The cavities 76C may be threaded in order to fix the sensors or the means. The sides of the adaptor 76 may comprise flat surfaces also designated as facets, which are used for installing the sensors, or the means 40M.

The nozzle 16 comprises the means 40M for measuring vibrations along the first direction D1 and the second direction D2. In one embodiment, the means 40M comprise a first vibration sensor 40F sensing vibrations in the first direction D1, and a second sensor 40S sensing vibrations in the second direction D2. These sensors may be accelerometers, for instance unidirectional accelerometers. In another embodiment, the means 40M comprise one single multi-directional accelerometer.

The cavities 76C are each used for attaching one of the sensors 40F and 40S. The cavities 76C may be threaded cavities. They may be blind, with a bottom separating the corresponding sensor from the body. Thus, a protecting interface is provided. In addition, the nozzle 16 is easier to produce, and its mechanical strength is preserved.

The features of each nozzle as described in relation with anyone of FIGS. 1 to 7 may be combined to the other nozzles, and vice-versa, unless the contrary is explicitly mentioned.

Each of the nozzles as described in relation with FIGS. 4 to 7 may be integrated in anyone of the abrasive waterjet cutting systems as described in relation with FIGS. 1 to 3 unless the contrary is explicitly mentioned.

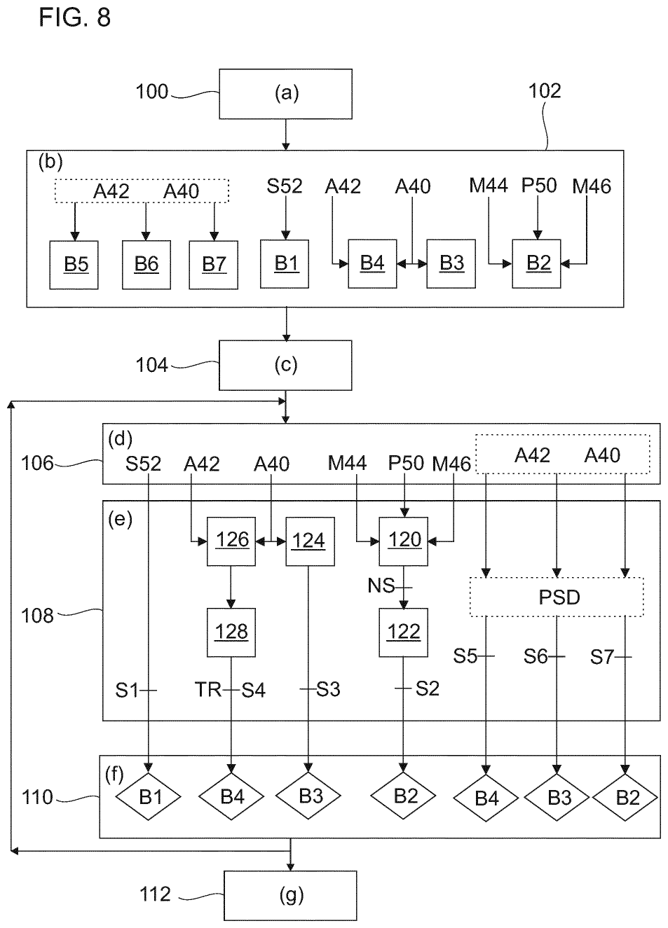

FIG. 8 provides a schematic illustration of a monitoring process of an abrasive waterjet cutting system. The abrasive waterjet cutting system may correspond to one of those described in relation with FIGS. 1 to 7.

The monitoring process may include the following steps, notably performed in the following order:

(a) maintenance 100 of the abrasive waterjet cutting head;

(b) defining 102 a benchmark of the abrasive waterjet cutting head by means of at least one of the upstream sensor and the downstream sensor, or more generally at least one of the first sensor and the second sensor;

(c) cutting 104 a workpiece with the abrasive waterjet;

(d) measuring 106 an upstream data and a downstream data with the upstream sensor and the downstream sensor respectively, or more generally a first data and a second data with the first sensor and the second sensor respectively;

(e) processing 108 the upstream data and/or the downstream data, or more generally the first data and/or the second data, in order to define a signature of the abrasive waterjet cutting head;

(f) comparing 110 the signature to the benchmark;

(g) producing 112 one or more output signals.

Step (a) maintenance 100 may comprise the mounting of a new nozzle, or the replacement of a worn nozzle by an unworn one. Step (a) maintenance 100 may include a correction of the alignment between the nozzle and the orifice. Alternatively or in addition, step (a) maintenance 100 may comprise a replacement of the orifice and/or a tightening of any screw connection.

At step (b) defining 102 a benchmark, the benchmark may be defined by means of in situ measurements. The measurements may be obtained by one of the sensors, notably one of the microphones and/or one of the accelerometers. If necessary, the benchmark may be determined by means of the orifice sensor, and/or the piezoelectric sensor.

Accordingly, the benchmark may be defined by at least one of, or any combination of the followings: an inlet signal A40 from the upstream accelerometer, an outlet signal A42 from the downstream accelerometer, an upstream signal M44 from the upstream microphone, a downstream signal M46 from the downstream microphone, a workpiece signal P50 from the piezoelectric sensor, and an orifice signal S52 from the orifice sensor.

At step (b) defining 102, the benchmark may enclose several sub-benchmarks. For instance, the benchmark may enclose a first benchmark B1, a second benchmark B2, a third benchmark B3, a fourth benchmark B4, a fifth benchmark B5, a sixth benchmark B6, a seventh benchmark B7 and so on. Each of these sub-benchmarks may be representative, independently, from one characteristic of the abrasive waterjet cutting system.

The benchmarks (B1-B7) may be benchmark signatures. They may be considered as static signatures, whereas the signatures to which they are compared are actually dynamic signatures, or real time signatures. They respectively correspond to past signatures and present signatures.

In addition, the benchmarks (B1-B7) may be calculated for one operating setpoint of the AWJ head as for a group of setpoints. This group of setpoints may form an Operation Space Domain (OSD).

The OSD may enclose any setpoint expected during operation. The OSD may reduce to one point if the head is expected to operate only at one single setpoint.

Step (b) defining 102 may comprise a training period during which the benchmarks (B1-B7) are calculated for each setpoint of the OSD. During the training period, the set point is varied within certain discrete points of OSD in order to explore it with sufficient resolution, and the correspondent benchmark may be recorded. Then, a general benchmark may be defined. The training period may be considered as an initial calibration, for instance carried out immediately after installation of a new nozzle. At step (f) comparing 110, the signature is compared against the corresponding benchmark for the instantaneous setpoint used at step (c) cutting 104.

The first benchmark B1 may be defined by means of the orifice sensor. The second benchmark B2 may be defined by means of the upstream microphone, the downstream microphone, and optionally the workpiece sensor. The third benchmark B3 may be defined by means of the upstream accelerometer. The fourth benchmark B4 may be defined by means of the upstream accelerometer and the downstream accelerometer.

The fifth to seventh benchmark B5 to B7 may be obtained defined in relation with power spectral densities, for instance of the upstream accelerometer or the downstream accelerometer, which may more generally be a first accelerometer or a second accelerometer. The fifth to seventh benchmark B5 to B7 may correspond to peaks obtained from power spectral densities. Mathematical operations may be computed on the peaks in order to define the benchmarks (B5-B7).

The benchmarks B1-B7 may be calculated by means of the computer, on previous signals which are eventually amplified, then acquired synchronously and A/D converted by means of acquisition board. The computer may comprise at least one computing module for computing the modules and the signature, or one module for each benchmark and the associated signature.

Alternatively, the benchmark may be theorical. It may correspond to a stored benchmark.

Step (d) measuring 106 may be continuous. It may be an obtaining step. Acquisition and A/D converting may also be continuous. Thus signal(s) may be continuously provided. The signals may be synchronized, and may form windowed signals. It may be understood that the windowed signals are signals of fixed time length.

At step (e) processing 108, the signature may encompass several sub-signatures, for instance a first signature S1, a second signature S2, a third signature S3, a fourth signature S4, and so on.

At least step (d) measuring 106, step (e) processing 108 and step (f) comparing 110 may be performed during step (c) cutting 104. Thus, the monitoring process may run continuously during cutting operations, and may go on running provided conformity requirements are met. Otherwise, step (g) producing 112 may be triggered during step (c) cutting 104.

Step (e) processing 108 may comprise the computation of the power spectral density (PSD) of the first sensor and/or of the second sensor. The power spectral density/densities may be used to define signatures, for instance a fifth signature, a sixth signature, and a seventh signature. The signatures may be computed in the manner as the associated benchmarks, respectively the fifth benchmark B5, the sixth benchmark B6 and the seventh benchmark B7.

Step (e) processing 108 may start every minute or every 20 seconds on the windowed signals within that time interval. For instance, windowed signals measured during 20 second are selected, and then processed in order to provide (a) corresponding signature(s). Thereafter, next windowed signals of 20 second are selected and processed. This may be repeated continuously, meaning that the monitoring is continuous 20 seconds windows may be comprised between time resolution and frequency resolution.

Step (d) measuring 106 may comprise a measurement of the pressure upstream the orifice. The orifice signal S52 from the orifice sensor may be used. The upstream data and the downstream data may correspond to an upstream data stream and a downstream data stream since they may be obtained from data flows over a period(s) of time.

Subsequently or simultaneously, step (e) processing 108 may comprise computing the static pressure and the dynamic pressure by means of Fourier Transform or Wavelet Transform. The latter may form the first signature S1. The first signature S1 may comprise a portion corresponding to the static pressure, and another portion corresponding to the dynamic pressure. Step (f) comparing 110 may comprise the comparison of said Fourier Transform or Wavelet Transform—the first signature S1—to the first benchmark B1. The result may inform about the current orifice wear.

During step (d) measuring 106, sound pressures may be measured by the microphones. Their upstream signal M44 and their downstream signal M46 may be used.

During step (e) processing 108, a calculation step 120 may provide a net signal NS on the basis of the signals M44 and M46. The net signal NS may carry information about the acoustic contribution of the abrasive waterjet from which the contribution from the workpiece is removed. In a general way, it may be considered that the contribution of the environment is removed from the acoustic contribution of the abrasive waterjet. A decorrelation technique may be used for computing the net signal, notably by a Singular Value Decomposition (SVD) algorithm. The pressure emitted by the abrasive waterjet may be isolated, and its quality may be precisely assessed.

During step (e) processing 108, a further calculation step 122 may compute the Fourier Transform or the Wavelet Transforms of the net signal NS. An Auto-Regressive Moving Average (ARMA) of the net signal NS may be computed and used for computing the Fourier Transform or the Wavelet transform in order to provide an output, notably a signature or a part of a signature. The calculation step 122 may provide the second signature S2.

Alternatively or in addition, a workpiece signal P50 from the piezoelectric sensor may be used.

This workpiece signal P50 may be used during the calculations step 120. The net signal NS may be calculated by a decorrelation technique, for instance with a Singular Value Decomposition (SVD) algorithm. Similarly, the net signal NS may carry information about acoustic contribution of waterjet from which the contribution from workpiece, and more generally the contribution of the environment, is removed. Then, the workpiece signal P50 may also be used for the computation of the second signature S2.

During step (f) comparing 110, the second signature S2 is compared to the second benchmark B2.

The result of this comparison may provide teaching about the characteristic of the abrasive waterjet, notably the quality of the cut it produces.

During the step (d) measuring 106, accelerations of the nozzle may be measured by the accelerometers. The inlet signal A40 and the outlet signal A42 may be used.

During step (e) processing 108, a calculation step 124 may provide Fourier or Wavelet Transform of the inlet signal A40. The Fourier transform or Wavelet Transform can be eventually computed on the ARMA estimate of the signals. This Fourier transform or Wavelet Transform may form a signature or a part of a signature. It may be a third signature S3, which may notably be compared to the third benchmark B3.

Due to the location of the upstream accelerometer, the third signature S3 may be correlated to jet-impinging conditions at the inlet section of the nozzle, and therefore to an eventual misalignment between the orifice and the nozzle. This misalignment may result from wear of the orifice, or from a misalignment of components during operation. The inlet signal A40 may be used, for instance alone.

During step (e) processing 108, a calculation step 126 may provide the Fourier Transforms or the Wavelet Transform of the upstream signal A40 and of the downstream signal A42. Through these Fourier Transforms (FTs) or Wavelet Transforms (WTs), a further calculation step 128 may provide the vibration transmissibility TR between the inlet and the outlet of the nozzle, for instance the vibration transmissibility TR between the inlet section and the outlet section of the nozzle. The vibration transmissibility TR may be obtained by dividing the Fourier Transform or Wavelet Transform of the upstream signal A40 by the Fourier Transform or Wavelet Transform of the downstream signal A42. In other words, the transmissibility TR may be computed as the ratio between the two spectra from Fourier Transforms of the accelerometer signals.

Such transmissibility TR is a structural feature of the nozzle; therefore, it may be correlated to its wear condition. The transmissibility TR may be considered as a signature or a part of the signature.

It may be a fourth signature S4, and may be compared to the fourth benchmark B4 in order to control the nozzle wear.

As apparent from the current description, step (b) defining 102 and step (d) measuring 106 may use the same signals A40, A42, M44, M46, P50 and S52. However, these steps compute the signals at different periods. These signals may change due to step (c) cutting 104, and due to the changing characteristics of the abrasive waterjet cutting system.

According to an option of the invention, each benchmark (B1-B7) may be calculated by means of the same calculation step(s) as its associated signature (S1-S7). An associated signature may be a signature to which a benchmark is compared.

Thus, the second benchmark B2 may be calculated on the basis of the signals M44, M46 and possibly M50, and by means of the calculation step 120 and the further calculation step 122 as set forth above. The calculation step 120 may be performed provided the workpiece is disposed in the abrasive waterjet cutting system. If the benchmark is calculated without workpiece, the calculation step 120 may be by-passed.

The third benchmark B3 may be calculated on the basis of the signal A40 and the calculation step 124 as set forth above. The fourth benchmark B4 may be calculated on the basis of the signals A40 and A42, and through the calculation step 126 and the calculations step 128 as set forth above.

The monitoring process may be an iterative monitoring process. It may repeat the calculations of signatures during step (e) processing 108, and the comparison of the signatures to their associated benchmarks during step (f) comparing 110. Yet, the measures of signals during step (d) measuring 106, may be continuous.

In a general way, N signatures are compared against the respective benchmarks (N represents a naturel number). And N output digital signals are outputted according to the comparison and they can be used for deciding whether performing maintenance or not, what kind of maintenance eventually, and/or controlling.

The monitoring process performs step (g) producing 112 an or several output signal(s) only if the signature exceeds a tolerance with respect to the benchmark. The output signal, for instance a digital signal, is notably processed for controlling or correcting a set point of the abrasive waterjet cutting head, or notably used for deciding a maintenance intervention.

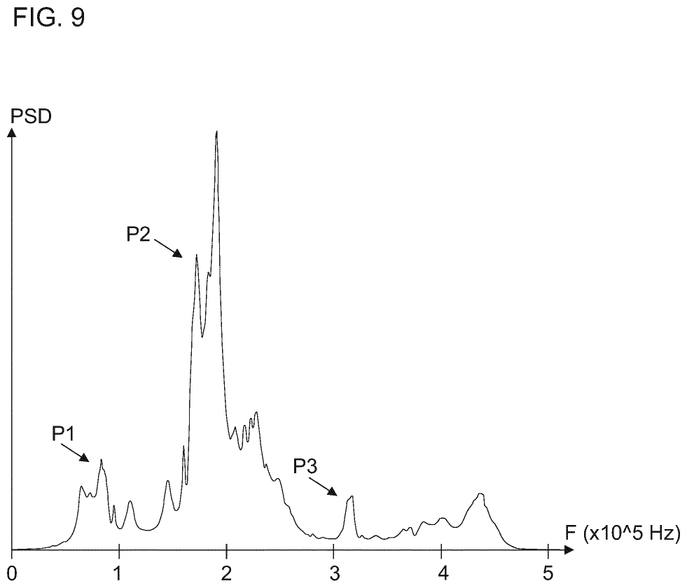

FIG. 9 is a power spectral density representation of vibrations measured by a sensor namely a one-dimensional accelerometer placed at the outlet section of the nozzle in an abrasive waterjet cutting system, for instance an abrasive waterjet cutting system similar or identical to the ones described in relation with FIGS. 1 to 7. The abscissa represents the frequency, and the ordinate the normalized amplitude.

The power spectral density curve includes several peaks. Here we identify three peaks for the sake of clarity: P1, P2 and P3. These peaks P1, P2 and P3 correspond to different features of the signals.

The peaks P1, P2 and P3 may be used for defining at least one of the first to seventh benchmarks, and at least one of the first to seventh signatures.

The invention comprises the definition of at least one range, or of different ranges. Each range encloses one of the peaks P1, P2 and P3, and may be centred thereon.

Each of said peaks might be correlated with one or more characteristics of the abrasive waterjet and/or with a wear characteristic of the nozzle.

Vibration of the outlet section of the nozzle might be measured in two directions both orthogonal, or more generally both transversal, to the axis of the nozzle. In that case, each of the peaks P1, P2, P3 in one direction can be associated with the correspondent twin peaks P1′, P2′, P3′ (not represented) in the other direction. A comparison between two twin peaks might allow to detect further characteristics of the abrasive waterjet, like for example alignment of the abrasive waterjet with the nozzle.

Said comparison might be a mathematical operation, such as a multiplication or a division.

A follow up and an analysis of the peaks P1, P2 and P3 is carried out in order to detect specific events.

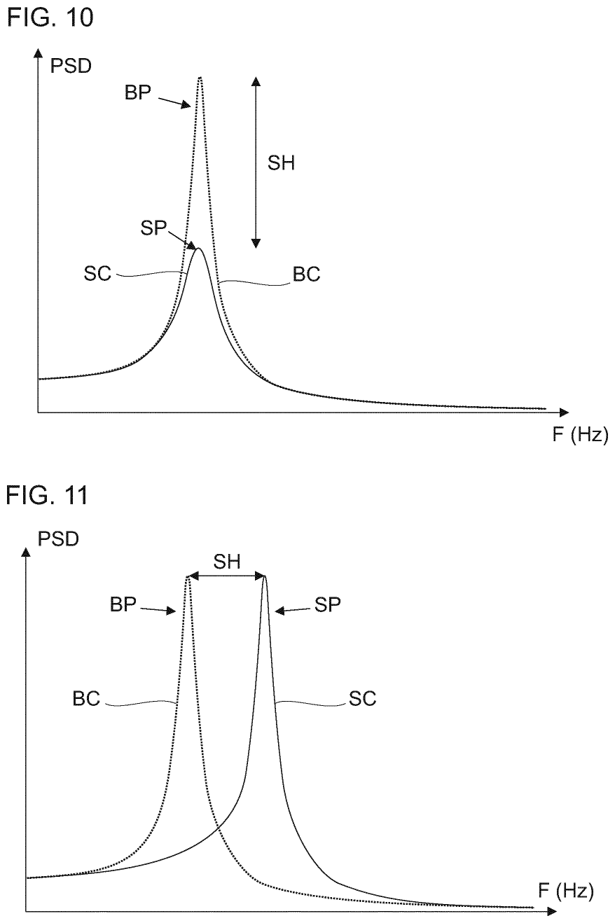

Each peak of FIG. 9 might be isolated as shown in FIG. 10 and FIG. 11. FIG. 10 is graphic with two plots of power spectral densities. The abscissa axis represents the frequency, and the ordinate axis the normalized amplitude. The two plots correspond to a theorical and simplified benchmark curve BC, and to an illustrative signature curve SC. These two plots are provided in order to illustrate a fashion of monitoring and comparing a signature over a benchmark.

The two curves comprise a benchmark curve BC with a benchmark peak BP; and a signature curve SC with a signature peak SP. A difference is apparent between the benchmark peak BP and the signature peak SP. The difference may correspond to a shift between the peaks PB and SP.

In the current illustration, the variation between the peaks PB and SP is to be observed along ordinate axis. Thus, there is an amplitude evolution between the peaks PB and SP. For instance, we may observe that the amplitude of the analysed peak reduces, such that the amplitude of the signature peak SP is smaller than the benchmark peak BP.

If the shift reaches or is higher than an amplitude threshold, then an action may be carried out or a signal may be sent.

In the current example, the amplitude of the benchmark peak BP is higher than the amplitude of the signature peak SP, however the contrary may be provided.

FIG. 11 is graphic with two plots of power spectral densities. The abscissa axis represents the frequency, and the ordinate axis the normalized amplitude.

The two curves comprise a benchmark curve BC with a benchmark peak BP; and a signature curve SC with a signature peak SP. A difference is apparent between the benchmark peak BP and the signature peak SP. The difference may correspond to a shift between the peaks PB and SP.

In the current illustration, the variation between the peaks PB and SP is to be observed along abscissa axis. Thus, there is a frequency evolution between the peaks PB and SP. For instance, we may observe that the frequency of the analysed peak increases, such that the frequency of the signature peak SP is higher than the benchmark peak BP.

when the shift reaches or is higher than a frequency threshold, then an action may be carried out or a signal may be sent.

In the current example, the frequency of the benchmark peak BP is lower than the frequency of the signature peak SP, however the contrary may be foreseen.

In a most general case, a peak might undergo amplitude and frequency shift both at the same time.

It should be understood that the detailed description of specific preferred embodiments is given by way of illustration only, since various changes and modifications within the scope of the invention will be apparent to the person skilled in the art. The scope of protection is defined by the following set of claims.

1. (canceled)

1. An abrasive waterjet cutting system, comprising:
an abrasive waterjet cutting head comprising:
a nozzle adapted for guiding an abrasive waterjet intended to cut a workpiece,
said nozzle including an inlet end and an outlet end;
an abrasive waterjet flow direction;
a monitoring device including at least first sensor and a second sensor which are distributed along the abrasive waterjet flow direction downstream the inlet end of the nozzle, and which are adapted for measuring at least one wear characteristic of the nozzle, or a characteristic of the abrasive waterjet (6), or an alignment characteristic of the nozzle with an orifice;
the monitoring device being configured to monitor at least one characteristic of the abrasive waterjet cutting system through at least the first sensor and the second sensor.

3. (canceled)

4. The abrasive waterjet cutting system according to claim 2, wherein the first sensor and the second sensor include a first accelerometer and a second accelerometer which are attached to the abrasive waterjet cutting head for measuring wear characteristics of the nozzle and/or misalignment of waterjet respect to nozzle.

5. The abrasive waterjet cutting system according to claim 4, wherein the abrasive waterjet cutting head includes a casing housing the nozzle, said casing including pockets where at least the second accelerometer is arranged.

6. The abrasive waterjet cutting system according to claim 4, wherein the nozzle includes an inlet section forming the inlet end and receiving the first accelerometer, and an outlet section forming the outlet end and receiving the second accelerometer; the inlet section and the outlet section each extend along at most 20% of the length of the nozzle.

7. The abrasive waterjet cutting system according to claim 4. wherein the nozzle includes a tubular body, the first accelerometer and the second accelerometer being directly in contact with said tubular body.

8. The abrasive waterjet cutting system according to claim 2, wherein the sensor and the second sensor include a first microphone and a second microphone disposed downstream the nozzle.

9. (canceled)

10. The abrasive waterjet cutting system according to claim 8, wherein the monitoring device further includes a piezoelectric sensor which is adapted for being fixed to the workpiece, the wear monitoring device being configured to monitor at least one characteristic of the abrasive waterjet cutting system through the piezoelectric sensor,

11. The abrasive waterjet cutting system according to claim 8, wherein along the abrasive waterjet flow direction, the abrasive waterjet cutting system includes a first distance D1 between the outlet end and the first microphone, and a second distance D2 between the first microphone and the second microphone, said second distance D2 being greater than the first distance D1.

12. (canceled)

13. The abrasive waterjet cutting system according to claim 2, wherein the abrasive waterjet cutting head encloses an orifice sensor, for measuring a fluid pressure upstream the orifice.

14. The abrasive waterjet cutting system according claim 2, wherein the first sensor and the second sensor form a first set of sensors, the monitoring device further including a second set of sensors comprising a first sensor and a second sensor which are adapted for measuring a wear characteristic of the nozzle and/or a characteristic of the abrasive waterjet, and/or an alignment characteristic of the nozzle with an orifice.

15-24. (canceled)

25. A nozzle for an abrasive waterjet cutting system, comprising:
a an essentially cylindrical body;
a passage across the cylindrical body for guiding an abrasive waterjet;
a longitudinal direction the passage;
a two longitudinally opposite end sections; and
a vibration sensor at at least one of the opposite end sections.

26. (canceled)

27. The nozzle according to claim 25, further comprising:
at least two flat surfaces adapted for receiving the vibration sensor, which are transversal with respect to each other, said at least two flat surfaces:
a being formed on the generally cylindrical outer surface

28. The nozzle according to claim 25. wherein the vibration sensor comprises accelerometers or strain gauges.

29-30. (canceled)

31. The nozzle according to claim 25, wherein said vibration sensor comprises two unidirectional accelerometers which are disposed in order to measure vibrations in the two transversal directions.

32-34. (canceled)

35. The nozzle according to claim 25, wherein the essentially cylindrical body comprises at least one facet adapted for receiving said vibration sensors.

36-37. (canceled)

38. The nozzle according to claim 25, wherein the nozzle comprises threaded holes for fixing the vibration sensor, said threaded holes being formed on the essentially cylindrical body or on an adaptor.

39. The nozzle according to claim 26, wherein the nozzle comprises a shield disposed between an outlet end of the nozzle and the vibration sensor.

40. A monitoring process of an abrasive wateijet cutting system, the abrasive wateijet cutting system comprising:
an abrasive waterjet cutting head with a nozzle guiding an abrasive waterjet, said nozzle including an inlet end and an outlet end;
an abrasive waterjet flow direction,
a monitoring device including a first sensor and a second sensor which are adapted for measuring a wear characteristic of the nozzle, or a characteristic of the abrasive waterjet, or an alignment characteristic of the nozzle with an orifice;
the monitoring process including the following steps:
defining a benchmark of the abrasive waterjet cutting head by at least one of the first sensor and the second sensor;
measuring a first data and a second data with the first sensor and the second sensor respectively;
processing the first data and the second data in order to define a signature of the abrasive waterjet cutting head; and
comparing the signature to the benchmark;

41-45. (canceled)

46. The monitoring process according to claim 40, further comprising:
cutting a workpiece with the abrasive waterjet, the measuring being performed during the cutting.

47. The monitoring process according to claim 40, further comprising:
in response to the signature exceeding a tolerance with respect to the benchmark, producing at least one output signal which is processed for controlling or correcting a set point of the abrasive waterjet cutting head, and/or used for deciding a maintenance intervention.

48-62. (canceled)

63. The abrasive waterjet cutting system according to claim 2, wherein the first sensor and the second sensor comprises a strain-gauge.
